(19) United States
(12) Patent Application Publication
(10) Pub. No.: US 2025/0272908 A1
(43) Pub. Date: Aug. 28, 2025

(54) SYSTEM AND METHOD FOR APPLYING A TEXTURE ON A 3D OBJECT

(71) Applicant: SAMSUNG ELECTRONICS CO., LTD., Suwon-si (KR)

(72) Inventors: Ankit Dhiman, Bengaluru (IN); Pushkar Raj Singh, Bengaluru (IN); Shubham Monga, Bengaluru (IN); Pranav Kumar, Bengaluru (IN); Basavaraja Shanthappa Vandrotti, Bengaluru (IN); Lokesh Rayasandra Boregowda, Bengaluru (IN); Vishal Bhushan Jha, Bengaluru (IN); Swadha Jaiswal, Bengaluru (IN)

(73) Assignee: SAMSUNG ELECTRONICS CO., LTD., Suwon-si (KR)

(21) Appl. No.: 19/074,970

(22) Filed: Mar. 10, 2025

Related U.S. Application Data
(63) Continuation of application No. PCT/KR2025/001863, filed on Feb. 7, 2025.

(30) Foreign Application Priority Data
Feb. 28, 2024 (IN) 202441014607

(51) Int. Cl. G06T 15/04; G06V 10/82

(52) U.S. Cl. CPC G06T 15/04; G06V 10/82

(57) ABSTRACT

A method for dynamically transferring a texture on a 3D object is disclosed. The method includes receiving a pattern associated with the texture to be applied onto the 3D object; identifying, using a vertex identification-based neural network, a set of vertices of a mesh of the 3D object; generating, using a texture generation-based neural network, respective texturing parameters for each vertex in the set of vertices based on the pattern, wherein the respective texturing parameters comprise a color vector and a displacement vector; generating a textured 3D object by applying the texture on the 3D object using the respective texturing parameters; and rendering a 2D image of the textured 3D object based on a rasterization of the textured 3D object.

### CROSS-REFERENCE TO RELATED APPLICATION(S)

This application is a bypass continuation of International Application No. PCT/KR2025/001863, filed on Feb. 7, 2025, which is based on and claims priority to Indian patent application Ser. No. 20/244,1014607, filed Feb. 28, 2024, in the Indian Intellectual Property Office, the disclosures of which are incorporated by reference herein in their entireties.

### FIELD

The present disclosure generally relates to image processing, and more particularly relates to a system and a method for applying a texture on a 3D object.

### BACKGROUND

Rendering/applying a texture on an object may be a process used in computer graphics for one or more purposes, such as architectural visualization, animation, video games, and the like. The texture may be rendered/applied on the object to bring realistic and detailed visual representation to three-dimensional (3D) models. Further, the rendering/applying of the texture on the object may involve applying a 2D image (which may be sometimes referred to as a texture map) onto the surface of a 3D object. There are multiple conventional solutions related to the rendering of the texture on the object. However, in the conventional solutions, textures and effects related to the rendering of the texture are pre-defined. Thus, a user is not allowed to create his/her custom textures or effects and apply them to 3D objects. For example, current effects on 3D meshes, such as Physically Based Rendering (PBR) pens, extrusion-based coloring, and the like, are pre-loaded on an electronic device, and not created by the user. Thus, the conventional solutions require a manual effort to create the texture and normal maps.

FIGS. 1A-1B illustrate a pictorial representation of an interface depicting a conventional solution for applying a mesh, according to a conventional technique. As can be seen from image 102 of FIG. 1A, there are multiple options (e.g., texture bar 104) available for a pre-loaded texture. Further, as can be seen from image 106 of FIG. 1B, a doodle 108 is rendered on the interface after selecting a 3D mesh from the multiple options. However, these effects configured for the 3D mesh based on doodle 108 of one shape cannot be applied to meshes of other shapes, such as 3D text. Also, in the conventional solution, rendering pipeline textures are parametrized by Ultra Violet (UV)-textures and do not account for curves and shapes of the input 3D object. As a result, artefacts are visible in multiple regions of the input 3D object. Furthermore, the conventional solution has limited options for effects in Augmented Reality (AR)/Virtual Reality (VR) applications.

Accordingly, there lies a need for a technique and method that can overcome each of the above-identified problems and limitations associated with the conventional solutions of applying the texture on the object.

### SUMMARY

This summary is provided to introduce a selection of concepts, in a simplified format, that are further described in the detailed description of the disclosure. This summary is neither intended to identify key or essential inventive concepts of the disclosure nor is it intended to determine the scope of the disclosure.

According to one embodiment of the present disclosure, a method for dynamically transferring a texture on a 3D object is disclosed. The method includes receiving a pattern associated with the texture to be applied onto the 3D object; identifying, using a vertex identification-based neural network, a set of vertices of a mesh of the 3D object; generating, using a texture generation-based neural network, respective texturing parameters for each vertex in the set of vertices based on the pattern, wherein the respective texturing parameters comprise a color vector and a displacement vector; generating a textured 3D object by applying the texture on the 3D object using the respective texturing parameters; and rendering a 2D image of the textured 3D object based on a rasterization of the textured 3D object.

According to another embodiment of the present disclosure, a method for applying a texture on a 3D object is disclosed. The method includes generating a mesh representation for the 3D object on which the texture is to be applied. Further, the method includes identifying a set of vertices in the generated mesh representation of the 3D object. The method also includes receiving an input pattern associated with the texture to be applied on the 3D object. Furthermore, the method includes generating, using a texture generation-based neural network based on the received input pattern and the identified set of vertices, one or more texturing parameters comprising a colour vector and a displacement vector for the received pattern and identified the set of vertices. The method also includes applying the texture on the 3D object by using the generated one or more texturing parameters.

According to another embodiment of the present disclosure, a system for dynamically transferring a texture on a 3D object is disclosed. The system includes one or more processors configured to receive a pattern associated with the texture to be applied onto the 3D object; identify, using a vertex identification-based neural network, a set of vertices of a mesh of the 3D object; generate, using the texture generation-based neural network, respective texturing parameters for each vertex in the set of vertices based on the pattern, wherein the respective texturing parameters comprise a color vector and a displacement vector; generating a textured 3D object by applying the texture on the 3D object by using the respective texturing parameters; and render a 2D image of the textured 3D object based on a rasterization of the textured 3D object.

According to another embodiment of the present disclosure, a non-transitory computer readable medium storing one or more instructions is disclosed. The one or more instructions when executed by at least one processor, can cause the at least one processor to receive a pattern associated with the texture to be applied onto the 3D object; identify, using a vertex identification-based neural network, a set of vertices of a mesh of the 3D object; generate, using a texture generation-based neural network, respective texturing parameters for each vertex in the set of vertices based on the pattern, wherein the respective texturing parameters comprise a color vector and a displacement vector; generate a textured 3D object by applying the texture on the 3D object using the respective texturing parameters; and render a 2D image of the textured 3D object based on a rasterization of the textured 3D object.

To further clarify the advantages and features of the present disclosure, a more particular description of the disclosure may be provided by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIGS. 1A-1B illustrate a pictorial representation of an interface depicting a conventional solution for applying a mesh, according to a conventional technique;

FIG. 2 illustrates a block diagram of a system for applying a texture on a 3D object, according to an embodiment of the present disclosure;

FIG. 3 illustrates a block diagram of a plurality of modules of the system shown in FIG. 2, according to an embodiment of the present disclosure;

FIG. 4A illustrates a flow chart depicting a training process of a texture generation-based neural network, according to an embodiment of the present disclosure;

FIG. 4B illustrates a pictorial depiction showing an input mesh excluding a texture, according to an embodiment of the present disclosure;

FIG. 4C illustrates a pictorial depiction showing a 3D mesh with a texture, according to an embodiment of the present disclosure;

FIG. 4D illustrates a pictorial depiction an operation of a differentiable renderer, according to an embodiment of the present disclosure;

FIG. 4E illustrates a pictorial representation for generating multiple augmentations of a rendered 2D view, according to an embodiment of the present disclosure;

FIGS. 4F-4G illustrate pictorial representations for generating the texture, according to an embodiment of the present disclosure;

FIG. 4H illustrates a pictorial representation of the texture generation-based neural network, according to an embodiment of the present disclosure;

FIGS. 5A-5G illustrate pictorial representations depicting multiple use-case scenarios for applying the texture on the 3D object, according to an embodiment of the present disclosure;

FIG. 6 illustrates an exemplary process flow depicting a method for applying the texture on the 3D object, according to an embodiment of the present disclosure; and

FIG. 7 illustrates an exemplary process flow depicting a method for applying the texture on the 3D object, according to another embodiment of the present disclosure.

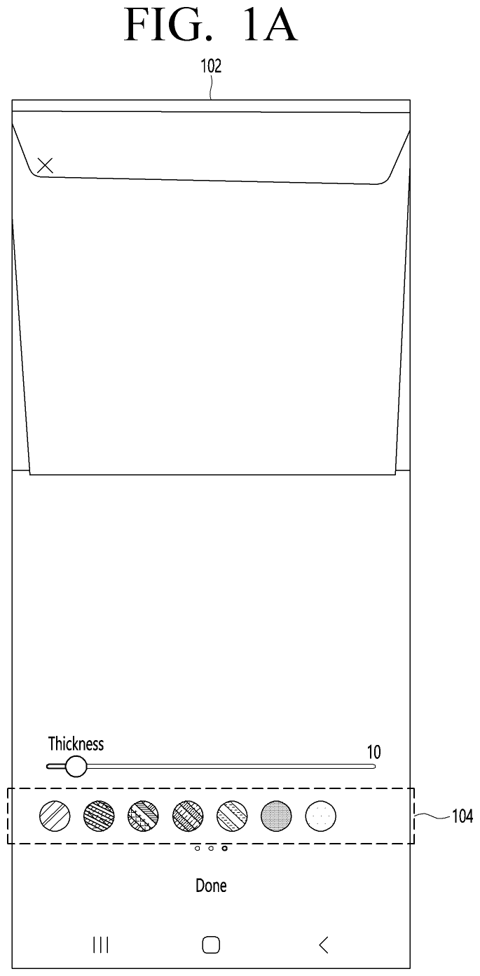

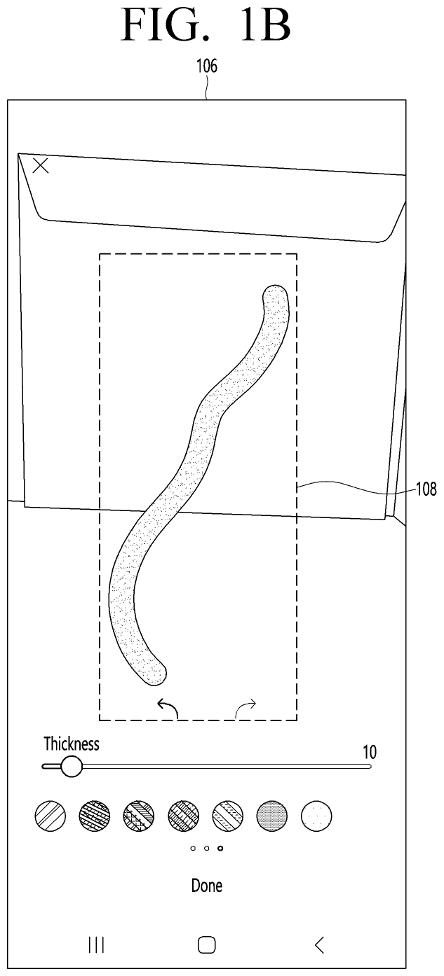

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols. The drawings may show only those specific details that are pertinent to understanding the embodiments of the present disclosure to avoid obscuring the drawings with details that will be readily apparent to those of ordinary skill in the art having the benefit of the description herein.

### DETAILED DISCLOSURE

For the purpose of promoting an understanding of the principles of the disclosure, reference will now be made to the various embodiments and specific language may be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

Those skilled in the art will understand that the foregoing general description and the following detailed description are explanatory of the disclosure and are not intended to be restrictive thereof.

Reference throughout this disclosure to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this disclosure may, but do not necessarily, all refer to the same embodiment.

The terms “comprises”, “comprising”, or any other variations thereof, are intended to cover a non-exclusive inclusion, such that a process or method that comprises a list of steps or operations does not include only those steps or operations but may include other steps or operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

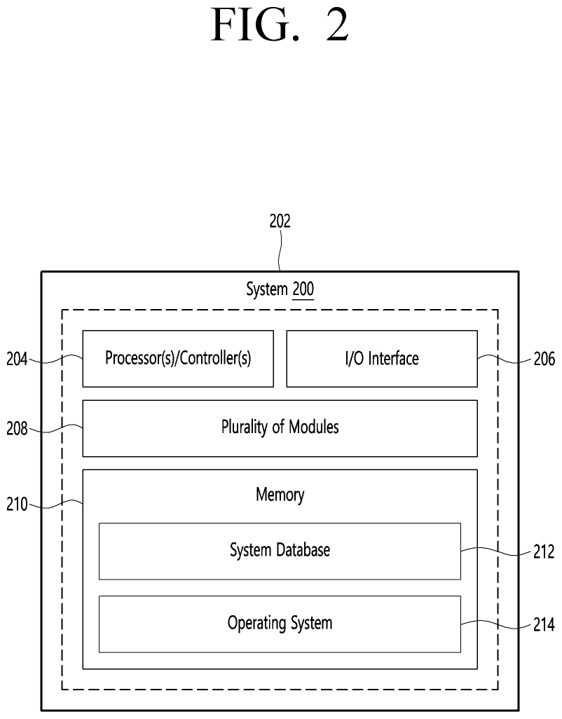

FIG. 2 illustrates a block diagram of a system 200 for applying a texture on a Three-Dimensional (3D) object, according to an embodiment of the present disclosure. In an embodiment of the present disclosure, the system is implemented in an electronic device 202. For example, the electronic device 202 may be, but is not limited to, a smartphone, a laptop, a wearable device, a Head Mounted Unit (HMU), and the like. In an embodiment of the present disclosure, the 3D object corresponds to an object that exists in a virtual or digital environment, such as Three Dimensional (3D) object, 2D object, and the like. Further, the texture corresponds to a text, an image or pattern applied to a surface of the 3D object to give it a realistic appearance.

The system 200 may include one or more processors/controllers 204, an Input/Output (I/O) interface 206, a plurality of modules 208, and a memory 210.

In an exemplary embodiment, one or more processors/controllers 204 may be operatively coupled to each of the respective I/O interface 206, the plurality of modules 208, and the memory 210. In one embodiment, one or more processors/controllers 204 may include at least one data processor for executing processes in a Virtual Storage Area Network. The one or more processors/controllers 204 may include specialized processing units such as integrated system (bus) controllers, memory management control units, floating point units, graphics processing units, digital signal processing units, etc. In one embodiment, the one or more processors/controllers 204 may include a Central Processing Unit (CPU), a Graphics Processing Unit (GPU), or both. The one or more processors/controllers 204 may be one or more general processors, digital signal processors, application-specific integrated circuits, field-programmable gate arrays, servers, networks, digital circuits, analog circuits, combinations thereof, or other now known or later developed devices for analyzing and processing data. The one or more processors/controllers 204 may execute a software program, such as code generated manually (e.g., programmed) to perform the desired operation. In an embodiment of the present disclosure, the processors/controllers 204 may be a general-purpose processor, such as the CPU, an Application Processor (AP), or the like, a graphics-only processing unit such as the GPU, a Visual Processing Unit (VPU), and/or an Artificial Intelligence (AI)-dedicated processor, such as a Neural Processing Unit (NPU).

Further, the one or more processors/controllers 204 control the processing of input data in accordance with a pre-defined operating rule or machine learning (ML) model stored in the non-volatile memory and the volatile memory. The pre-defined operating rule or the ML model is provided through training or learning.

Here, being provided through learning means that, by applying a learning technique to a plurality of learning data, a pre-defined operating rule or the ML model of a desired characteristic is made. The learning may be performed in the electronic device 202 itself in which ML according to an embodiment is performed, and/or may be implemented through a separate server/system.

Furthermore, the ML model may consist of a plurality of neural network layers. Each layer has a plurality of weight values and performs a layer operation through the calculation of a previous layer and an operation of a plurality of weights. Examples of neural networks include but are not limited to, Convolutional Neural Networks (CNN), Deep Neural Networks (DNN), Recurrent Neural Networks (RNN), Restricted Boltzmann Machine (RBM), Deep Belief Networks (DBN), Bidirectional Recurrent Deep Neural Network (BRDNN), Generative Adversarial Networks (GAN), and deep Q-network.

The learning technique is a method for training a predetermined target device (for example, a robot) using a plurality of learning data to cause, allow, or control the target device to decide or predict. Examples of learning techniques include, but are not limited to, supervised learning, unsupervised learning, semi-supervised learning, or reinforcement learning.

The one or more processors/controllers 204 may be disposed in communication with one or more input/output (I/O) devices via the respective I/O interface 206. The I/O interface 206 may employ communication code-division multiple access (CDMA), high-speed packet access (HSPA+), global system for mobile communications (GSM), long-term evolution (LTE), WiMax, or the like, etc.

The one or more processors/controllers 204 may be disposed of in communication with a communication network via a network interface. In an embodiment, the network interface may be the I/O interface 206. The network interface may connect to the communication network to enable the connection of the electronic device 202 with the other devices. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, and the like.

In some embodiments, the memory 210 may be communicatively coupled to the one or more processors/controllers 204. The memory 210 may be configured to store data, and instructions executable by the one or more processors/controllers 204. The memory 210 may include but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 210 may include a cache or random-access memory for the one or more processors/controllers 204. In alternative examples, the memory 210 may be a part of the one or more processors/controllers 204, such as a cache memory of a processor, the system memory, or other memory. In some embodiments, the memory 210 may be an external storage device or database for storing data. The memory 210 may be operable to store instructions executable by the one or more processors/controllers 204. The functions, acts, or tasks illustrated in the figures or described may be performed by the programmed processor/controller for executing the instructions stored in the memory 210. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

In some embodiments, the plurality of module 208 may be included within the memory 210. The memory 210 may further include a system database 212 to store data. The plurality of modules 208 may include a set of instructions that may be executed to cause the system 200 to perform any one or more of the methods/processes disclosed herein. The plurality of modules 208 may be configured to perform the operations of the present disclosure using the data stored in the system database 212 for applying the texture on the 3D object in the electronic device 202, as discussed herein. In an embodiment, each of the plurality of modules 208 may be a hardware unit that may be outside the memory 210. Further, the memory 210 may include an operating system 214 for performing one or more tasks of the system 200, as performed by an operating system 214 in the communications domain. In one embodiment, the system database 212 may be configured to store the information as required by the plurality of modules 208 and the one or more processors/controllers 204 for applying the texture on the 3D object.

In an embodiment of the present disclosure, at least one of the plurality of modules 208 may be implemented through the ML model. A function associated with the ML may be performed through the non-volatile memory, the volatile memory, and the one or more processors 204.

In an embodiment, the I/O interface 206 may enable input and output to and from the system 200 using suitable devices such as, but not limited to, a display, a keyboard, a mouse, a touch screen, a microphone, a speaker, and so forth.

Further, the present disclosure also contemplates a computer-readable medium that includes instructions or receives and executes instructions responsive to a propagated signal. Further, the instructions may be transmitted or received over the network via a communication port or interface or using a bus (not shown). The communication port or interface may be a part of the one or more processors/controllers 204 or may be a separate component. The communication port may be created in software or may be a physical connection in hardware. The communication port may be configured to connect with a network, external media, the display, or any other components in the electronic device 202, or combinations thereof. The connection with the network may be a physical connection, such as a wired Ethernet connection, or may be established wirelessly. Likewise, the additional connections with other components of the electronic device 202 may be physical or may be established wirelessly. The network may alternatively be directly connected to the bus. brevity person of skill in the art would know the architecture and standard operations of the operating system 214, the memory 210, the system database 212, the one or more processors/controllers 204, and the I/O interface 206.

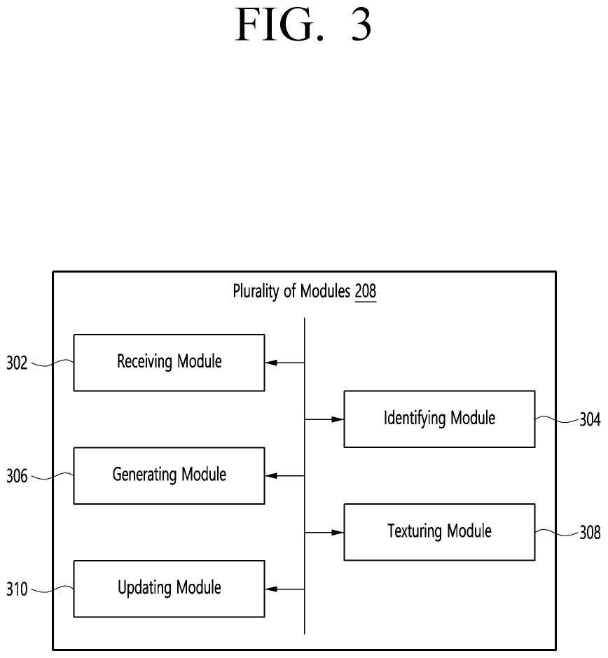

FIG. 3 illustrates a block diagram of a plurality of modules of the system 200 shown in FIG. 2, according to an embodiment of the present disclosure. In an embodiment of the present disclosure, the plurality of modules 208 may include but is not limited to, a receiving module 302, an identifying module 304, a generating module 306, a texturing module 308, and an updating module 310. The plurality of modules 208 may be implemented by way of suitable hardware and/or software applications.

In an embodiment of the present disclosure, the receiving module 302 may be configured to receive the pattern associated with the texture to be applied onto the 3D object. In an exemplary embodiment of the present disclosure, the method includes receiving a user input indicative of the pattern. In an embodiment of the present disclosure, the 3D object corresponds to a 3D object mesh. Further, the pattern may include an input text prompt or an input texture patch. For example, the input text prompt corresponds to a textual command or instruction provided to a machine learning model, for generating the one or more texturing parameters. In an embodiment of the present disclosure, the input texture patch corresponds to at least one portion of an image.

Further, the identifying module 304 may be configured to identify, using a vertex identification-based neural network, a set of vertices of a mesh of the 3D object. In an embodiment of the present disclosure, the mesh is a component used to represent the geometry and structure of the 3D object. For example, the mesh is a collection of faces, vertices, and edges that defines a shape, structure, and surface of a 3D object within a virtual environment.

For identifying the set of vertices, the identifying module 304 may be configured to generate a mesh representation of the 3D object on which the texture is to be applied. The identifying module 304 may be configured to identify the set of vertices in the generated mesh representation of the 3D object. Further, the identifying module 304 may be configured to obtain the 3D object to be textured. In an embodiment of the present disclosure, the obtained 3D object excludes the texture. The identifying module 304 may be configured to generate, using a texture generation-based neural network, the texture based on the obtained 3D object. Furthermore, the identifying module 304 may be configured to uniformly sample, using a differentiable renderer, a set of camera poses of the 3D object from different camera angles. The identifying module 304 may also be configured to render, using a differentiable renderer, a 2D image of the 3D object based on the uniformly sampled set of camera poses. In an embodiment of the present disclosure, the neural network requires a gradient for the weight-update operation during training. Hence, to ensure that gradients are properly back-propagated from the semantic loss, the differentiable renderer is used.

In an embodiment of the present disclosure, for generating the texture, the identifying module 304 may be configured to determine vertex coordinates corresponding to each of the set of vertices without texture. Further, the identifying module 304 may be configured to predict a color vector and a displacement vector based on the determined vertex coordinates. The identifying module 304 may be configured to generate the texture based on the predicted color vector and the predicted displacement vector. In an embodiment of the present disclosure, the color vector is vector of 3 values: {red, green, blue} to represent a colour. Further, the displacement vector is vector representing direction and magnitude in 3D: {x, y, z}.

Further, the updating module 310 may be configured to generate a plurality of augmentations corresponding to a rendered view of the 2D image of the 3D object. In an exemplary embodiment of the present disclosure, the generated plurality of augmentations includes a cropping of the rendered 2D image, a change in the background of the rendered 2D image, and an addition of noise to the rendered 2D image. Further, the updating module 310 may be configured to compute, based on the generated set of augmentations, a semantic loss value based on an input text prompt and an input texture patch included in the pattern. The updating module 310 may also be configured to update, using the differentiable renderer, weights of one or more layers of the neural network based on the computed semantic loss.

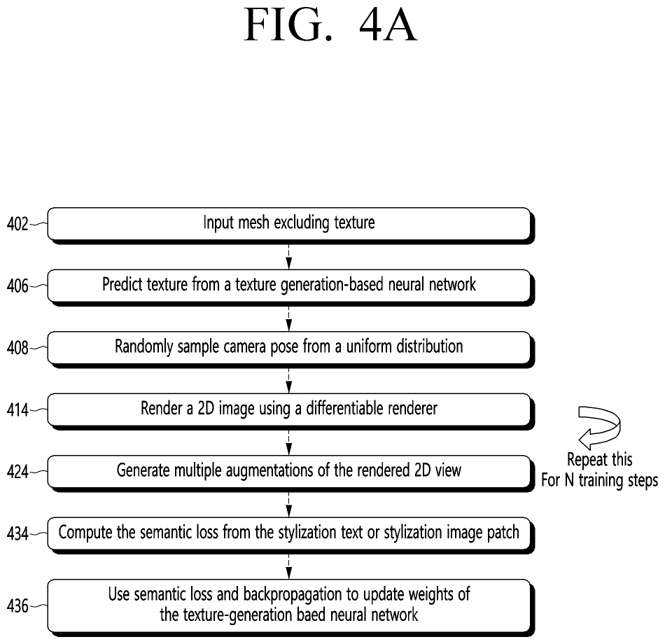

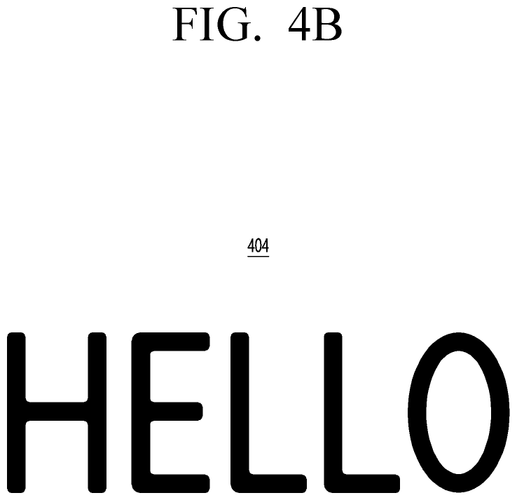

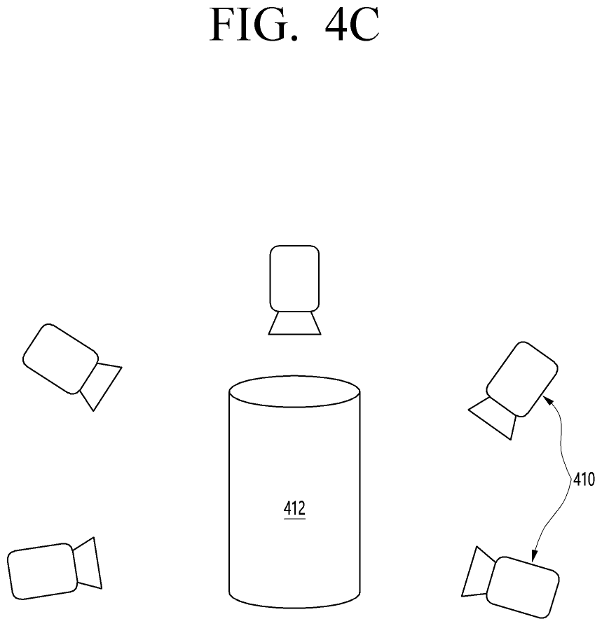

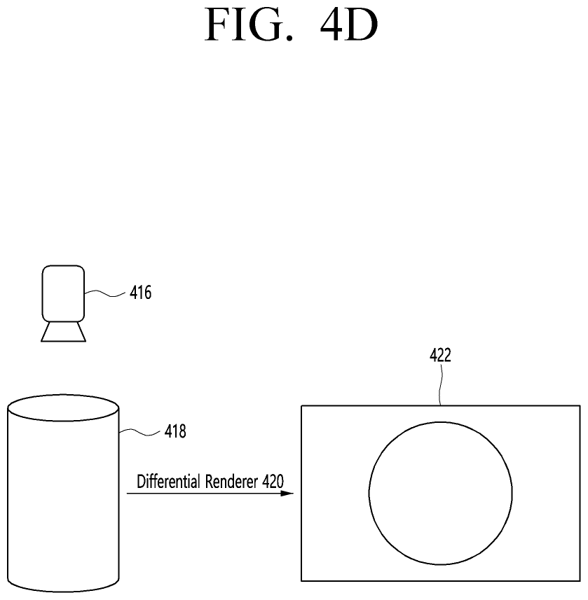

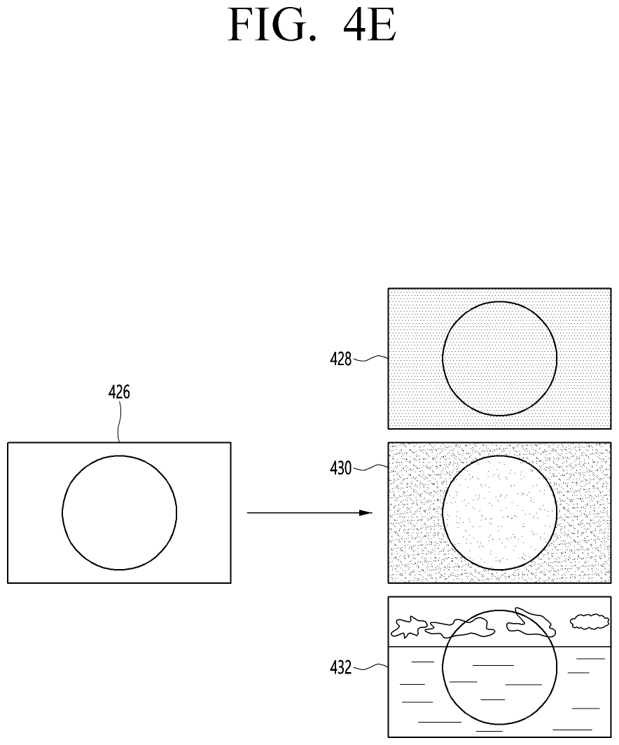

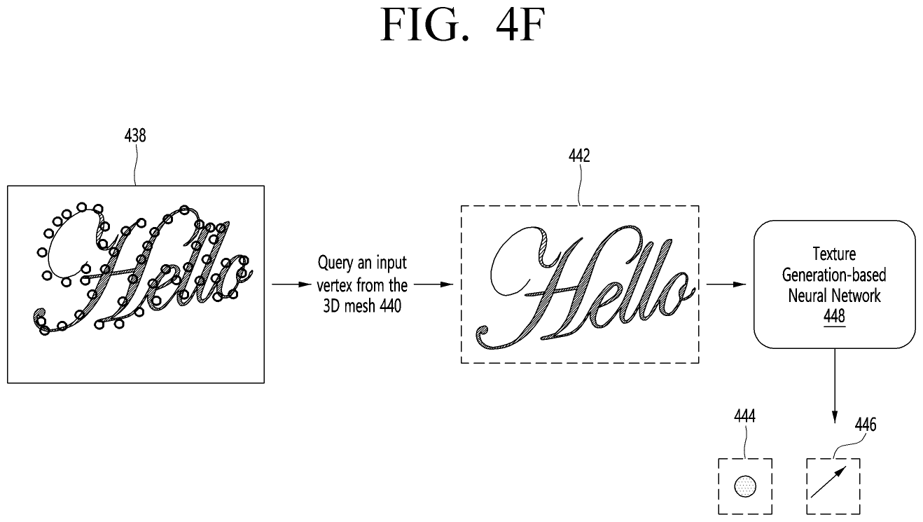

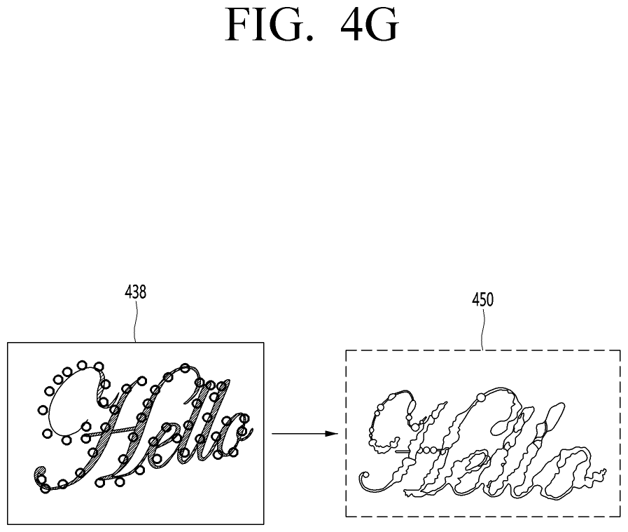

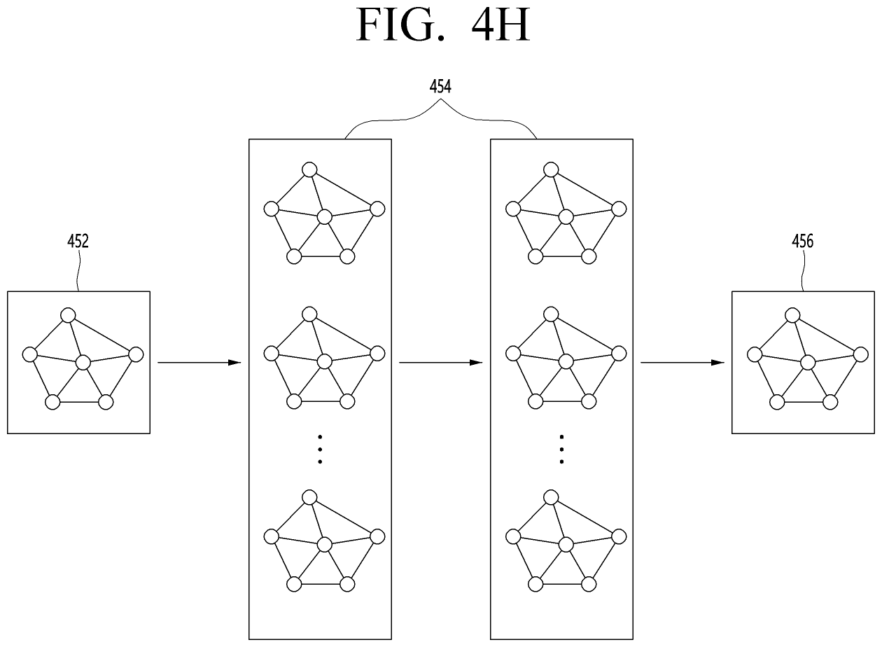

Further, the generating module 306 may be configured to generate, using the texture generation-based neural network, one or more texturing parameters. In an exemplary embodiment of the present disclosure, the one or more texturing parameters include a color vector and a displacement vector for the received pattern and identified the set of vertices. The details on the training of the texture generation-based neural network have been elaborated in subsequent paragraphs at least with reference to FIGS. 4A-4H.

Furthermore, the texturing module 308 may be configured to apply the texture on the 3D object by using the generated one or more texturing parameters.

In another embodiment of the present disclosure, the generating module 306 may be configured to generate the mesh representation for the 3D object on which the texture is to be applied. Further, the identifying module 304 may be configured to identify the set of vertices in the generated mesh representation of the 3D object. The receiving module 302 may be configured to receive the input pattern associated with the texture to be applied on the 3D object. In an embodiment of the present disclosure, the input pattern includes an input text prompt or an input texture patch. For example, the input texture patch corresponds to at least one portion of the image. Furthermore, the generating module 306 may be configured to generate, using a texture generation-based neural network based on based on the received input pattern and the identified set of vertices, the one or more texturing parameters. In an embodiment of the present disclosure, the one or more texturing parameters include the color vector and the displacement vector for the received pattern and identified the set of vertices. The texturing module 308 may be configured to apply the texture on the 3D object by using the generated one or more texturing parameters.

In an embodiment of the present disclosure, the texture generation-based neural network operates on vertices of the input 3D mesh to generate texture, normal and distance maps. The texture map is applied to the surfaces of the 3D object/3D model to create repeating texture patterns or special visual effects. In an embodiment of the present disclosure, the repeating texture patterns may be invariant to the actual shape and geometry of the 3D mesh. Further, the normal map adds fake depth on the surface of the 3D object for better photo-realism. Normal maps enable the surface of the 3D object bumpy. The current pipeline considers the actual/initial geometry of the 3D mesh. The color and displacement vectors predicted by the texture generation-based neural network may be used to change this actual/initial mesh geometry to match the texture pattern.

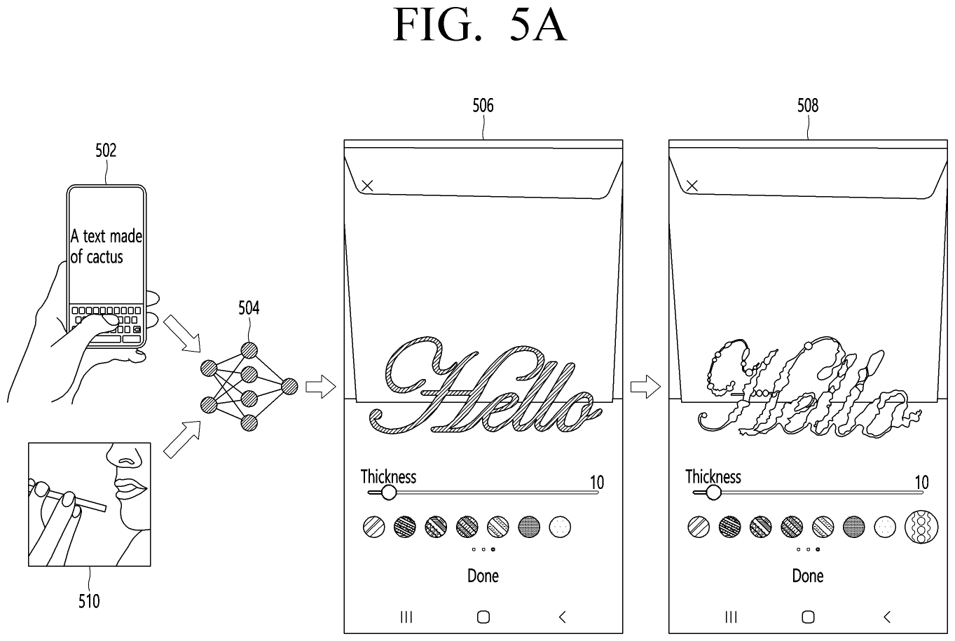

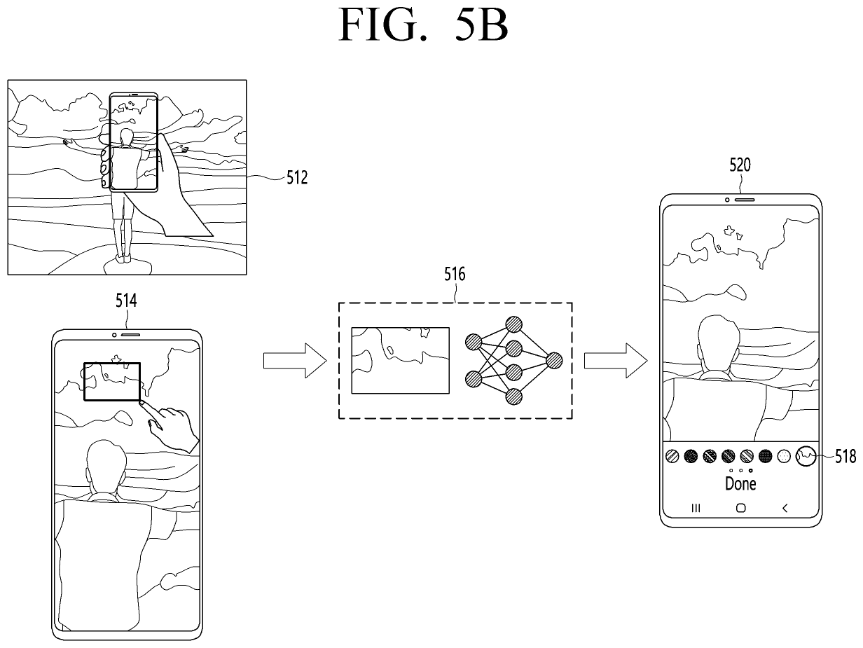

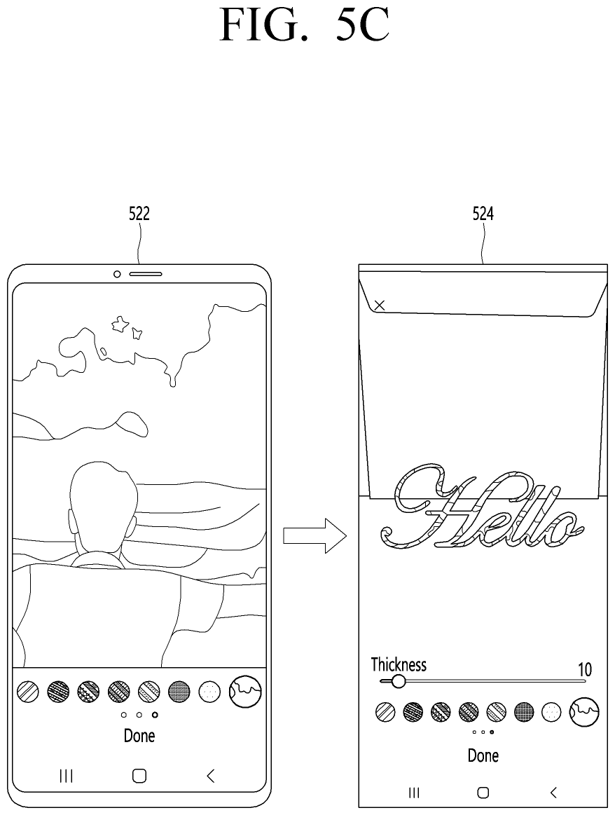

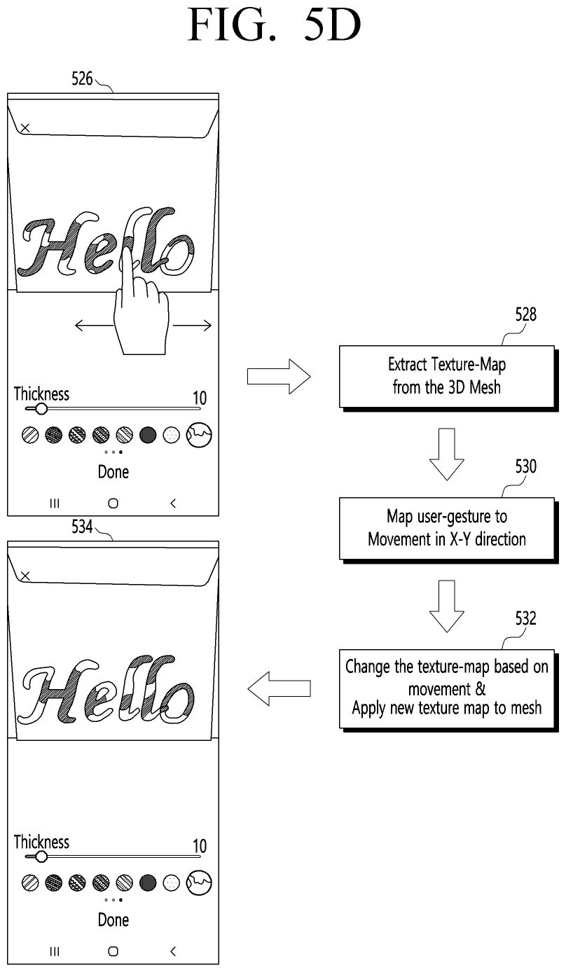

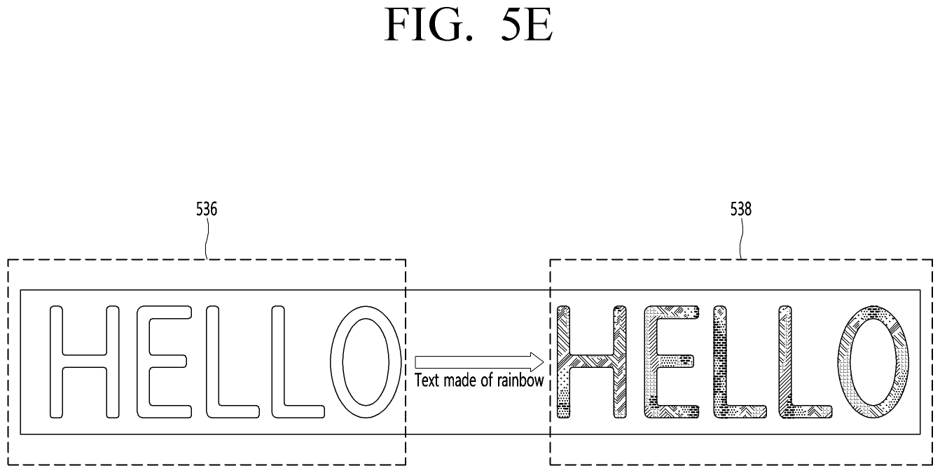

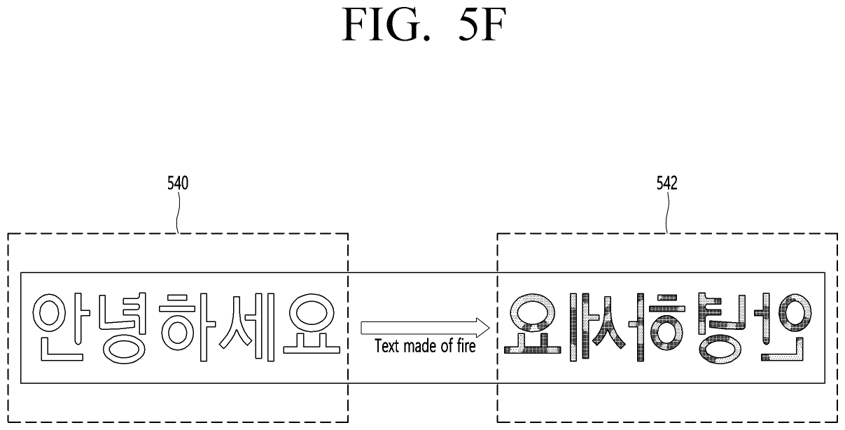

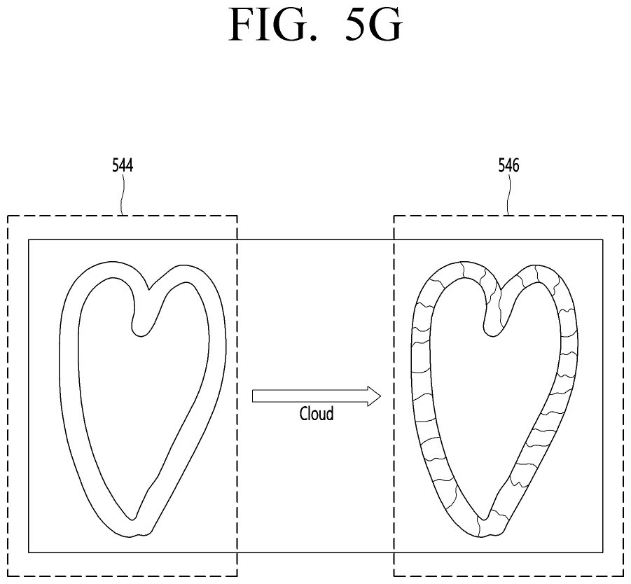

The operation of the system 200 has been elaborated in subsequent paragraphs at least with reference to FIGS. 4, 5, and 6 by using multiple use-case scenarios at least with reference to FIGS. 5A-G.

FIG. 4A illustrates a flow chart depicting a training process of the texture generation-based neural network, according to an embodiment of the present disclosure. FIG. 4B illustrates a pictorial depiction showing an input mesh excluding the texture, according to an embodiment of the present disclosure. FIG. 4C illustrates a pictorial depiction showing a 3D mesh with a texture, according to an embodiment of the present disclosure. Further, FIG. 4D illustrates a pictorial representation depicting an operation of the differentiable renderer, according to an embodiment of the present disclosure. Furthermore, FIG. 4E illustrates a pictorial representation for generating the multiple augmentations of a rendered 2D view, according to an embodiment of the present disclosure. FIGS. 4F-4G illustrate pictorial representations for generating the texture, according to an embodiment of the present disclosure. Further, FIG. 4H illustrates a pictorial representation of the texture generation-based neural network, according to an embodiment of the present disclosure. For the sake of brevity, FIGS. 4A-4G have been explained together. The details of the training of the texture generation-based neural network have been explained in detail with reference to FIG. 3.

As shown in FIG. 4A, at operation 402, the system 200 receives the input mesh excluding the texture. In an exemplary embodiment of the present disclosure, the input mesh excluding the texture corresponds to an input 3D mesh which does not have texture information. For example, the image 404 comprises vertices (3D points of the mesh) and triangle faces. A texture-less mesh can have other graphic attributes, such as normal and tangent.

Further, at operation 406 of FIG. 4A, the system 200 predicts the texture using the texture generation-based neural network. In an embodiment of the present disclosure, the neural network is parametrized by learnable weights. The texture generation-based neural network takes 3D vertices of the input mesh and outputs the colour, normal and displacement for the input vertex. For example, for predicting the color for one single vertex using the texture generation-based neural network, a (x, y, z) vertex coordinate of the input mesh is received excluding the texture. Further, the texture generation-based neural network is queried using these input coordinates. Further, the color and displacement vectors are predicted for the input vertex. These operations may be repeated for all the vertices in the input mesh excluding the texture to get color value for each vertex. As a result, the texture is generated for the input 3D mesh.

Furthermore, at operation 408 in FIG. 4A, the system 200 randomly samples the camera pose from a uniform distribution. In randomly sampling the camera pose, the system 200 renders the 3D mesh from different camera angles using the differentiable renderer. In order to propagate loss with respect to the token (input text/input image-patch), the 3D model is projected to a 2D projective image. For projecting the 3D model to the 2D projective image, a camera pose is required around the 3D mesh. In FIG. 4C, the set of camera poses 410 is depicted around the 3D mesh 412. In an embodiment of the present disclosure, a camera pose is randomly sampled from all such possible camera configurations during training.

Further, at operation 414 in FIG. 4A, the system 200 renders the 2D image using the differentiable renderer. Given the camera pose, a 2D image is rasterized using the differentiable renderer. The differentiable renderer is used by the system 200, such that the gradient can back-propagate to the texture generation-based neural network. As shown in FIG. 4D, image 416 represents a sampled camera pose and image 418 represents 3D mesh with texture. Further, the differentiable renderer 420 is used to rasterize the 2D image. The rasterized 2D image is represented by image 422.

Furthermore, at operation 424 in FIG. 4A, the system 200 generates the plurality augmentations of the rendered 2D view. In an exemplary embodiment of the present disclosure, the generated plurality of augmentations includes a cropping of the rendered 2D image, a change in the background of the rendered 2D image, and an addition of noise to the rendered 2D image. As shown in FIG. 4E, the system 200 pastes the rendered 2D image 426 upon a single-color black background 428. Further, the system 200 pastes the rasterized image on a random noisy background 430. The system 200 pastes the rasterized image on a natural image background 432. In an embodiment of the present disclosure, these augmentations facilitate in better results.

At operation 434, the system 200 computes the semantic loss from the stylization text or stylization image patch. In an embodiment of the present disclosure, the stylization text corresponds to a text token describing what kind of effect/style/texture may be used to modify the 3D mesh. For example, a mesh made of cactus, or a mesh made of rainbow. Further, the stylization image patch corresponds to an image patch comprising of texture which may be used to modify the texture of the 3D mesh. In an embodiment of the present disclosure, the semantic loss is a function which takes an image and a stylization token (text/image-patch) and returns proximity (similarity) between the image and the stylization token, semantically. If the image and the stylization token are similar, the function returns very little value and returns high values when they are dissimilar. In an embodiment of the present disclosure, the semantic loss is defined using Eqn (1):

$$F ( I , S ) \to v \qquad Eqn ( 1 )$$

In Eqn (1), f is the semantic loss function, I is the image, S is the stylization token and v is the loss value.

In an embodiment of the present disclosure, the system 200 considers the semantic loss between these augmentations and the image token. In an embodiment of the present disclosure, the augmented images are considered to compute the semantic loss with an input text prompt or image patch. At operation 436, the semantic loss is then back-propagated to update the weights of the texture generation-based neural network. In an embodiment of the present disclosure, all training operations may be repeated multiple times.

In an embodiment of the present disclosure, the texture generation-based neural network is trained using zero-shot. To create the texture generation-based neural network using the zero-shot, a single mesh is used. For example, when the user trains the texture generation-based neural network on mesh A, the user can use the same trained texture generation-based neural network to make inferences on mesh B, mesh C, and the like. As a result, no further training is required for inferencing on mesh B, mesh C, and the like.

As depicted, FIG. 4F shows the training pipeline of the texture generation-based neural network. The system 200 receives the input mesh excluding texture, as shown in image 438. Further, at operation 440, the system 200 queries the input vertex from the 3D mesh. The image 442 represents the X, Y, and Z coordinates of the input 3D mesh. Furthermore, the system 200 predicts the color vector 444 and the displacement vector 446 from the texture generation-based neural network 448. In an embodiment of the present disclosure, the training pipeline operations may be repeated for all the vertices. The image 450 of FIG. 4G represents the texture after iterating through all the vertices.

As depicted in FIG. 4H, 452 represents the input pattern. Further, 454 represents the set of hidden layers associated with the texture generation-based neural network. In an embodiment of the present disclosure, 456 represents the output 3D mesh with texture. In an embodiment of the present disclosure, each node of the graph associated with the texture generation-based neural network consists of position-encoded (x, y, z) location. Further, the output of each node of the graph is a color value (e.g., Red, Green, and Blue). In an embodiment of the present disclosure, the system 200 considers the geometry of the neighboring graph nodes which uses a single 3D point.

FIGS. 5A-5G illustrate pictorial representations depicting multiple use-case scenarios for applying the texture on the 3D object, according to an embodiment of the present disclosure. For the sake of brevity, FIGS. 5A-5G have been explained together.

In a use-case scenario depicted in FIG. 5A, the image 502 represents that the user writes a text prompt through a keyboard of the electronic device 202. Further, the texture generation-based neural network 504 extracts the text prompt and processes the extracted text prompt. In the current use-case scenario, the text prompt may be “a text made of cactus”. Further, image 506 represents the input 3D mesh. Furthermore, image 508 represents the 3D mesh with texture (e.g., cactus texture). In an embodiment of the present disclosure, the image 508 may perform one or more movements, such as rotation. In another embodiment of the present disclosure, the user may also provide the input by speaking the text prompt through Automatic Speech Recognition (ASR), as shown in image 510.

In a use-case scenario depicted in FIG. 5B, the user previews a scene as shown in image 512. Further, the user selects an image patch for the new texture, as shown in image 514. Furthermore, the patch is processed through the texture generation-based neural network, as shown in image 516. The new texture 518 is added to the palette, as shown in image 520.

In another use-case scenario depicted in FIG. 5C, image 522 represents the input 3D mesh and image 524 represents the 3D mesh with a new texture (e.g., cloud texture).

In another use-case scenario depicted in FIG. 5D, the system 200 allows the user to interact with the mesh to change texture application. The image 526 represents the mesh with the texture map. Further, at operation 528, the system 200 extracts the texture map from the mesh. Furthermore, the user performs the movement with respect to the mesh. At operation 530, the system 200 maps the user gesture (e.g., user movement) to the movement in the X-Y direction. Further, at operation 532, the system changes the texture (e.g., texture map) based on the result of the mapping. Further, the system 200 applies the new texture to the mesh. Further, image 534 represents the new texture of the mesh.

In a use-case scenario depicted in FIG. 5E, image 536 represents the input 3D mesh. The user provides a text prompt “text made of rainbow”. Further, image 538 represents the 3D mesh with the texture (e.g., rainbow texture).

In a use-case scenario depicted in FIG. 5F, image 540 represents the input 3D mesh. The user provides a text prompt “text made of fire”. Further, image 542 represents the 3D mesh with the texture (e.g., fire texture). The system identifies the set of vertices of the mesh of the input 3D mesh. Further, the system generates the one or more texturing parameters including the color vector and the displacement vector for the received text prompt and the identified the set of vertices. The system further applies the texture on the 3D object by using the generated one or more texturing parameters. In another use-case scenario, the system 200 may be used to generate the 3D mesh with textures, such as clouds, fire and ice, cactus, strawberries, cherry blossoms, and the like.

In a use-case scenario depicted in FIG. 5G, image 544 represents the input 3D mesh e.g., a heart-shared 3D mesh. The user provides a text prompt “text made of cloud”. Further, image 546 represents the 3D mesh with the cloud texture. Similarly, the system 200 may be used to generate the 3D meshes with the texture, for example, fire, cactus, strawberries, cherry blossom, and the like.

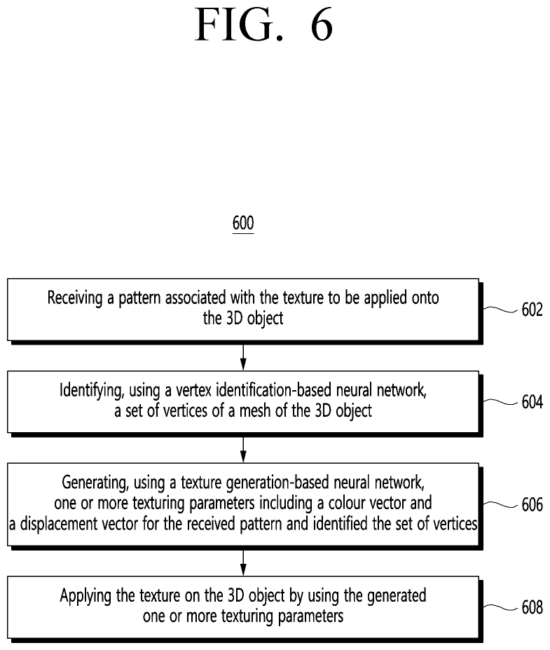

FIG. 6 illustrates an exemplary process flow depicting a method 600 for applying the texture on the 3D object, according to an embodiment of the present disclosure. The method 600 may be performed by a system 200 implemented in the electronic device 202, as shown in FIGS. 2 and 3.

At operation 602, the method 600 includes receiving a pattern associated with the texture to be applied onto the 3D object. In an embodiment of the present disclosure, the method 600 includes receiving a user input indicative of the pattern. For example, the 3D object corresponds to a Three-Dimensional (3D) object mesh. In an embodiment of the present disclosure, the pattern includes an input text prompt or an input texture patch. The input texture patch corresponds to at least one portion of an image.

At operation 604, the method 600 includes identifying, using a vertex identification-based neural network, a set of vertices of a mesh of the 3D object. For identifying the set of vertices, the method 600 includes generating a mesh representation of the 3D object on which the texture is to be applied. Further, the method 600 includes identifying the set of vertices in the generated mesh representation of the 3D object.

In an embodiment of the present disclosure, the method 600 includes obtaining the 3D object to be textured, wherein the obtained 3D object excludes the texture. The method 600 includes generating, using the neural network, the texture based on the obtained 3D object. Furthermore, the method 600 includes uniformly sampling, using a differentiable renderer, a set of camera poses of the 3D object from different camera angles. The method 600 includes rendering, using the differentiable renderer, a 2D image of the 3D object based on the uniformly sampled set of camera poses.

For generating the texture, the method 600 includes determining vertex coordinates corresponding to each of the set of vertices without texture. The method 600 includes predicting a color vector and a displacement vector based on the determined vertex coordinates. Further, the method 600 includes generating the texture based on the predicted color vector and the predicted displacement vector.

In an embodiment of the present disclosure, the method 600 includes generating a plurality of augmentations corresponding to a rendered view of the 2D image of the 3D object. In an embodiment of the present disclosure, the generated plurality of augmentations includes a cropping of the rendered 2D image, a change in a background of the rendered 2D image, and an addition of noise to the rendered 2D image. The method 600 includes computing, based on the generated set of augmentations, a semantic loss value based on an input text prompt and an input texture patch included in the pattern. Further, the method 600 includes updating, using the differentiable renderer, weights of one or more layers of the neural network based on the computed semantic loss.

At operation 606, the method 600 includes generating, using the texture generation-based neural network, one or more texturing parameters including a color vector and a displacement vector for the received pattern and identified the set of vertices.

Further, the method 608 includes applying the texture on the 3D object by using the generated one or more texturing parameters.

While the above operations shown in FIG. 6 are described in a particular sequence, the operations may occur in variations to the sequence in accordance with various embodiments of the present disclosure. Further, the details related to various operations of FIG. 6, which are already covered in the description related to FIGS. 2-5 are not discussed again in detail here for the sake of brevity.

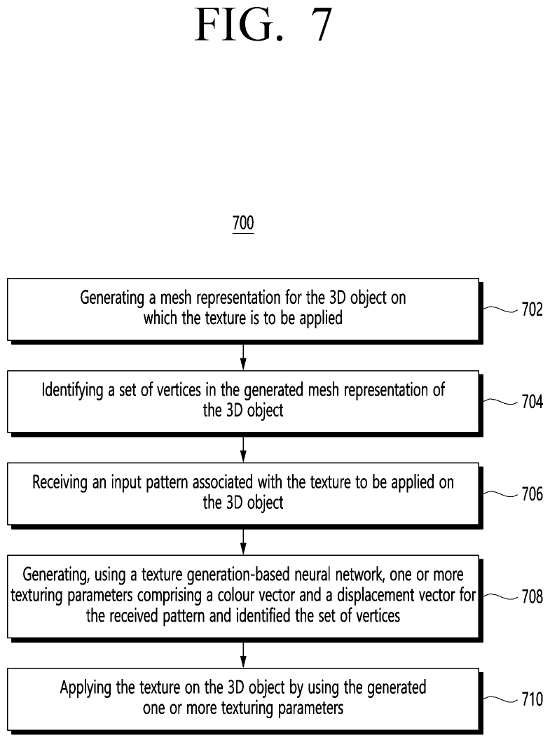

FIG. 7 illustrates an exemplary process flow depicting a method for applying the texture on the 3D object, according to another embodiment of the present disclosure.

At operation 702, the method 700 includes generating a mesh representation for the 3D object on which the texture is to be applied. In an embodiment of the present disclosure, the input pattern includes an input text prompt or an input texture patch. The input texture patch corresponds to at least one portion of an image.

At operation 704, the method 700 includes identifying a set of vertices in the generated mesh representation of the 3D object.

At operation 706, the method 700 includes receiving an input pattern associated with the texture to be applied on the 3D object.

Further, at operation 708, the method 700 includes generating, using a texture generation-based neural network based on based on the received input pattern and the identified set of vertices, one or more texturing parameters comprising a color vector and a displacement vector for the received pattern and identified the set of vertices.

At operation 710, the method 700 includes applying the texture on the 3D object by using the generated one or more texturing parameters.

While the above operations shown in FIG. 7 are described in a particular sequence, the operations may occur in variations to the sequence in accordance with various embodiments of the present disclosure. Further, the details related to various operations of FIG. 7, which are already covered in the description related to FIGS. 2-6 are not discussed again in detail here for the sake of brevity.

The present disclosure provides for various technical advancements based on the key features discussed above. The present disclosure applies aesthetically pleasing, vivid and abstract textures/effects to the geometric entities such as text, 3D meshes or primitive shapes in 3D. Further, the present disclosure also discloses a method for generating texture (custom texture effects) for arbitrary geometric meshes using text prompts or image patch guidance. Current effects may be pre-defined and do not let users create their own effects. However, the present disclosure allows a user to create such effects and apply them to texture-less 3D meshes. Furthermore, the present disclosure also creates bump maps/normal maps for better photo-realism. For example, the AI-based texture model A trained on an input “X” works on any other 3D object as well. Thus, no re-training is required. In an embodiment of the present disclosure, the present disclosure creates a generalizable texture generation model which works for text, primitive meshes in 3D, and the like. The present disclosure enables better photo-realism when visualized in an Augmented Reality (AR)/Virtual Reality (VR) world. For example, when a user observes a texture in the real world or wants to use a text prompt corresponding to an abstract texture, the present disclosure allows the user to provide inputs for applying effects in the AR/VR world on 3D texts or 3D primitive meshes.

Further, the present disclosure allows a user to provide an input either as an image patch or a text prompt (both representative of a texture) and outputs a model which operates on vertices of the input 3D mesh to generate texture, normal and distance maps. Further, the present disclosure allows a user to save this model on the electronic devices, such that the saved model may be used for creating texture, normal and distance maps for another kind of input 3D meshes. This solves a major issue of “personalization” in the current AR/VR world and enhances the user experience. The present disclosure can be used with the current hardware of the electronic devices.

The plurality of modules 208 may be implemented by any suitable hardware and/or set of instructions. Further, the sequential flow illustrated in FIG. 3 is exemplary and the embodiments may include the addition/omission of steps and operations as per the requirement. In some embodiments, the one or more operations performed by the plurality of modules 208 may be performed by the processor/controller based on the requirement.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method for dynamically transferring a texture on a 3D object, the method comprising:
receiving a pattern associated with the texture to be applied onto the 3D object;
identifying, using a vertex identification-based neural network, a set of vertices of a mesh of the 3D object;
generating, using a texture generation-based neural network, respective texturing parameters for each vertex in the set of vertices based on the pattern, wherein the respective texturing parameters comprise a color vector and a displacement vector;
generating a textured 3D object by applying the texture on the 3D object using the respective texturing parameters; and
rendering a 2D image of the textured 3D object based on a rasterization of the textured 3D object.

2. The method of claim 1, wherein the pattern is received based on a user input.

3. The method as claimed in claim 1, wherein the 3D object corresponds to a Three-Dimensional (3D) object mesh.

4. The method as claimed in claim 1, wherein:
the pattern comprises one of an input text prompt or an input texture patch, and
the input texture patch corresponds to at least one portion of an image.

5. The method as claimed in claim 1, wherein, for identifying the set of vertices, the method comprises:
generating a mesh representation of the 3D object on which the texture is to be applied; and
identifying the set of vertices in the mesh representation of the 3D object.

6. The method as claimed in claim 5, wherein, the rendering the 2D image of the textured 3D object comprises:
obtaining the 3D object to be textured, wherein the 3D object excludes the texture;
generating, using the texture generation-based neural network, the texture based on the 3D object;
uniformly sampling, using a differentiable renderer, a set of camera poses of the 3D object from a plurality of different camera angles; and
rendering, using the differentiable renderer, the 2D image of the textured 3D object based on the uniformly sampled set of camera poses.

7. The method as claimed in claim 6, wherein, for generating the texture, the method comprises:
determining vertex coordinates corresponding to each of the set of vertices without texture;
predicting the color vector and the displacement vector based on the determined vertex coordinates; and
generating the texture based on the color vector and the displacement vector.

8. The method as claimed in claim 6, further comprising:
generating a plurality of augmentations corresponding to a rendered view of the 2D image of the textured 3D object;
computing, based on the plurality of augmentations, a semantic loss value based on an input text prompt or an input texture patch included in the pattern; and
updating, using the differentiable renderer, weights of one or more layers of the texture generation-based neural network based on the semantic loss value.

9. The method as claimed in claim 8, wherein the plurality of augmentations includes a cropping of the rendered 2D image, a change in a background of the rendered 2D image, and an addition of noise to the rendered 2D image.

10. A system for dynamically transferring a texture on a 3D object, the system comprising:
memory; and
one or more processors communicably coupled to the memory, the one or more processors are configured to:
receive a pattern associated with the texture to be applied onto the 3D object;
identify, using a vertex identification-based neural network, a set of vertices of a mesh of the 3D object;
generate, using the texture generation-based neural network, respective texturing parameters for each vertex in the set of vertices based on the pattern, wherein the respective texturing parameters comprise a color vector and a displacement vector;
generating a textured 3D object by applying the texture on the 3D object by using the respective texturing parameters; and
render a 2D image of the textured 3D object based on a rasterization of the textured 3D object.

11. The system of claim 10, wherein the pattern is received based on a user input.

12. The system of claim 10, wherein the 3D object corresponds to a Three-Dimensional (3D) object mesh.

13. The system of claim 10, wherein:
the pattern comprises one of an input text prompt or an input texture patch, and
the input texture patch corresponds to at least one portion of an image.

14. The system of claim 10, wherein in identifying the set of vertices, the one or more processors are configured to:
generate a mesh representation of the 3D object on which the texture is to be applied; and
identify the set of vertices in the mesh representation of the 3D object.

15. The system as claimed in claim 14, wherein, when rendering the 2D image of the textured 3D object, the one or more processors are further configured to:
obtain the 3D object to be textured, wherein the 3D object excludes the texture;
generate, using the texture generation-based neural network, the texture based on the 3D object;
uniformly sample, using a differentiable renderer, a set of camera poses of the 3D object from a plurality of different camera angles; and
rendering, using the differentiable renderer, the 2D image of the 3D object based on the uniformly sampled set of camera poses.

16. A non-transitory computer readable medium storing one or more instructions that when executed by at least one processor, cause the at least one processor to:
receive a pattern associated with the texture to be applied onto the 3D object;
identify, using a vertex identification-based neural network, a set of vertices of a mesh of the 3D object;
generate, using a texture generation-based neural network, respective texturing parameters for each vertex in the set of vertices based on the pattern, wherein the respective texturing parameters comprise a color vector and a displacement vector;
generate a textured 3D object by applying the texture on the 3D object using the respective texturing parameters; and
render a 2D image of the textured 3D object based on a rasterization of the textured 3D object.

17. The non-transitory computer-readable medium of claim 16, wherein:
the pattern comprises one of an input text prompt or an input texture patch, and the input texture patch corresponds to at least one portion of an image.

18. The non-transitory computer-readable medium of claim 16, wherein the rendering the 2D image of the textured 3D object comprises:
obtaining the 3D object to be textured, wherein the 3D object excludes the texture;
generating, using the texture generation-based neural network, the texture based on the 3D object;
uniformly sampling, using a differentiable renderer, a set of camera poses of the 3D object from a plurality of different camera angles; and
rendering, using the differentiable renderer, the 2D image of the texture 3D object based on the uniformly sampled set of camera poses.

19. The non-transitory computer-readable medium of claim 18, wherein the generating the texture comprises:
determining vertex coordinates corresponding to each of the set of vertices without texture;
predicting the color vector and the displacement vector based on the determined vertex coordinates; and
generating the texture based on the color vector and the displacement vector.

20. The non-transitory computer-readable medium of claim 19, wherein the one or more instructions when executed by at least one processor further cause the at least one processor to:
generate a plurality of augmentations corresponding to a rendered view of the 2D image of the textured 3D object;
compute, based on the plurality of augmentations, a semantic loss value based on an input text prompt or an input texture patch included in the pattern; and
update, using the differentiable renderer, weights of one or more layers of the texture generation-based neural network based on the semantic loss value.
